(19) United States
(12) Patent Application Publication
(10) Pub. No.: US 2004/0087312 A1
(43) Pub. Date: May 6, 2004

(54) Network for mobile telecommunications, and communicating data from a base station to a base station controller

(76) Inventors: Qiang Cao, Swindon (GB); Patrick Georges Venceslas Charriere, Tetbury (GB); Seau Sian Lim, Swindon (GB); Philip Charles Sapiano, Corsham (GB)

Correspondence Address: Lucent Technologies Inc., Docket Administrator, (Room 3J-219), 101 Crawfords Corner Road, Holmdel, NJ, 07733-3030, US

(21) Appl. No.: 10/659,512

(22) Filed: Sep. 10, 2003

(30) Foreign Application Priority Data
Nov. 5, 2002 (EP) 02257635.9

(51) Int. Cl. H04Q 7/20; H04B 7/15

(52) U.S. Cl. 455/453; 455/423; 455/11.1

(57) ABSTRACT

A method is provided of communicating data over an interface from a base station of a network for mobile telecommunications to a base station controller. The base station controller is operative to control the base station. The method comprises storing user data and diagnostic data for transmission, selecting user data for transmission in preference to diagnostic data, and selecting diagnostic data traffic for transmission when no user traffic data is stored for transmission.

### CROSS REFERENCE TO RELATED APPLICATION

This application claims priority of European Application No. 02257635.9 filed on Nov. 5, 2002.

### TECHNICAL FIELD

The present invention relates to telecommunications, and more particularly, wireless communications.

### BACKGROUND OF THE INVENTION

One of the key factors in successful deployment of a network for mobile telecommunications is the ability to observe diagnostic information in order to determine system problems.

Networks in accordance with wideband-code division multiple access (W-CDMA) standards, such as the Universal Mobile Telecommunications System (UMTS) standard, allow a limited amount of diagnostic information to be passed along signalling channels between a radio network controller (RNC) and base station (Node-B in UMTS terminology) over an interface (IuB interface in UMTS terminology). The information passed between them is restricted to a limited number of messages.

The problems that existing UMTS networks have in handling diagnostic information from remote locations are that the available bandwidth is limited to cover the normal signalling scenarios, and communications over the IuB interface are limited to the commands defined within the standard. Due to the above limitations, much of the diagnostic information is instead usually retrieved by an operations, administration and maintenance (OA&M) engineer making a visit directly to a site to connect a computer directly into the base station (Node-B) situated there in order to obtain the diagnostic information.

UMTS networks make use of layered protocols, whereby transport channels are mapped onto and so transmitted using physical channels.

### SUMMARY OF THE INVENTION

The present invention provides a method of communicating data over an interface from a base station of a network for mobile telecommunications to a base station controller operative to control the base station, comprising storing user data and diagnostic data for transmission, selecting user data for transmission in preference to diagnostic data, and selecting diagnostic data traffic for transmission when no user traffic data is stored for transmission.

The network may be a Universal Mobile Telecommunications System (UMTS) network, the controller is a radio network controller (RNC), and the interface may be an IuB interface.

The diagnostic data may be provided to a local maintenance terminal connected to the controller for inspection.

There may be a plurality of data communication channels between the base station and the controller over the interface, one channel being a diagnostic data channel, and another channel being a user data channel, the base station includes a plurality of data buffers such that data of each channel for transmission is stored before transmission in a respective buffer, the buffers each including an occupancy indicator so that user data may be selected for transmission in preference to data from the buffer for diagnostic data.

The controller includes a plurality of further data buffers, such that control data of each channel for transmission to the base station may be stored before transmission in a respective buffer, the further buffers each including an occupancy indicator so that user channel control data may be selected for transmission in preference to diagnostic channel control data.

The diagnostic data channel may be set up in response to a request from the controller to the base station, and control data, which may be a request for diagnostic data may be sent by the controller to the base station, diagnostic data being sent in response.

Updated diagnostic data may be sent periodically until control data, which is a command to stop sending diagnostic data is received by the base station.

The base station controller may be at a distance away from the base station, and may be distant from the base station.

The present invention may also provide a network for mobile telecommunications comprising a base station connected via an interface with a base station controller operative to control the base station, the base station comprising storing means operative to store user data and diagnostic data for transmission, selecting means operative to select user data for transmission in preference to diagnostic data and to select diagnostic data traffic for transmission when no user traffic data is stored for transmission.

The network may be a Universal Mobile Telecommunications System (UMTS) network, the controller is a radio network controller (RNC), and the interface may be an IuB interface.

The network further comprises a local maintenance terminal connected to the controller for inspection of the diagnostic data.

In use there may be a plurality of data communication channels between the base station and the controller over the interface, one channel being a diagnostic data channel, and another channel being a user data channel, the base station may include a plurality of data buffers such that data of each channel for transmission is stored before transmission in a respective buffer, the buffers each including an occupancy indicator so that user data may be selected for transmission in preference to data from the buffer for diagnostic data.

The controller may include a plurality of further data buffers, such that control data of each channel for transmission to the base station may be stored before transmission in a respective buffer, the further buffers each including an occupancy indicator so that user channel control data is selected for transmission in preference to diagnostic channel control data.

In use the diagnostic data channel may be set up in response to a request from the controller to the base station, and control data, which may be a request for diagnostic data is sent by the controller to the base station, diagnostic data being sent in response.

The base station may be operative to send updated diagnostic data periodically until control data, which may be a command to stop sending diagnostic data values is received by the base station.

The base station controller may be at a distance away from the base station, and may be distant from the base station.

Embodiments of the present invention may provide a method for remote capture of diagnostic information from a wireless base station. Embodiments enable the sending of diagnostic information from a remote base station to the radio network controller (RNC), e.g., for observation, at a high rate, e.g., in real time, whilst using the existing infra-structure and not impacting user traffic services. This enables field faults and problems to be resolved rapidly, improving the reliability of the network

The technique may allow passing of diagnostic information back from a base station to the radio network controller (RNC), and optionally then on to an operations and maintenance centre (OMC). The technique may be applicable in wideband code division multiple access (W-CDMA) networks, such as Universal Mobile Telecommunications System (UMTS) networks.

### BRIEF DESCRIPTION OF THE DRAWINGS

The present invention will be better understood from reading the following description of non-limiting embodiments, with reference to the attached drawings, wherein below:

FIG. 1 is a diagram illustrating a UMTS network (UTRAN); and

FIG. 2 is a diagram illustrating the messaging sequence between a base station and its controlling radio network controller (RNC).

It should be emphasized that the drawings of the instant application are not to scale but are merely representations and thus are not intended to portray the specific parameters or the structural details of the invention, which may be determined by one of skill in the art by examination of the information contained herein.

### DETAILED DESCRIPTION

One type of wideband code division multiple access (W-CDMA) network is a Universal Mobile Telecommunications System (UMTS) terrestrial radio access network (UTRAN).

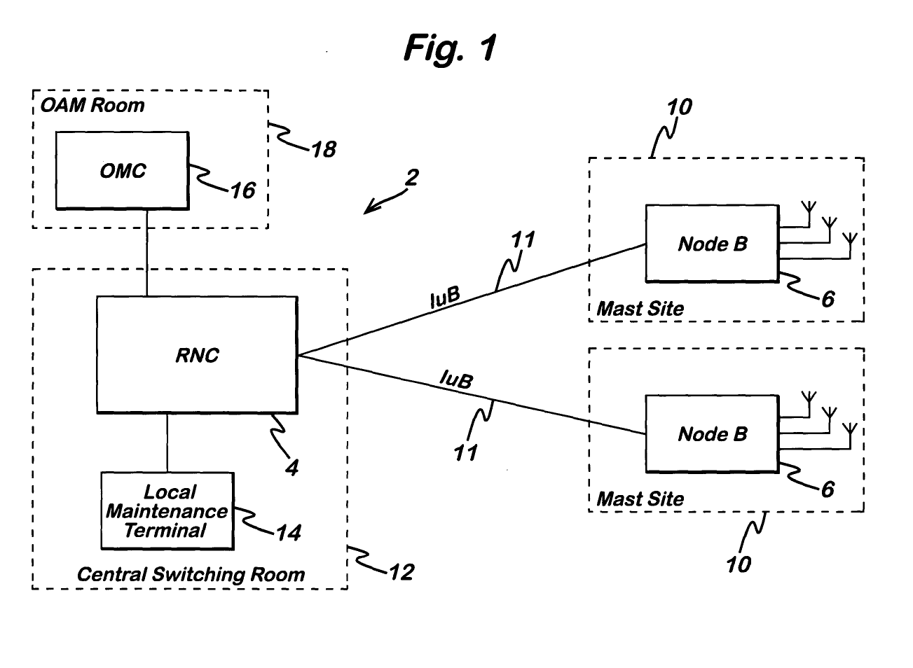

The architecture of a Universal Mobile Telecommunications System (UMTS) terrestrial radio access network (UTRAN) 2 is basically as shown in FIG. 1. In the Figure only one radio network controller 4 and two base stations 6 are shown for simplicity. Each base station (Node-B in UMTS terminology) 6 of the network 2 typically has three radio coverage areas (i.e. cells, also known as sectors) as the base station has three directional antennas 8 angled at 120 degrees to each other. Radio network controllers (RNC) 4 each control several base stations 6 and hence a number of cells.

As shown in FIG. 1, each base station is at a respective mast site 10. The radio network controller (RNC) controlling a base station is typically several miles from that base station. The radio network controller (RNC) is located in a central switching room 12. The radio network controller (RNC) includes a local maintenance terminal 14 whereby an engineer can gain access.

The radio network controller (RNC) is connected to an operations and maintenance centre (OMC) 16 located in an operations, administration and maintenance (OAM) room 18.

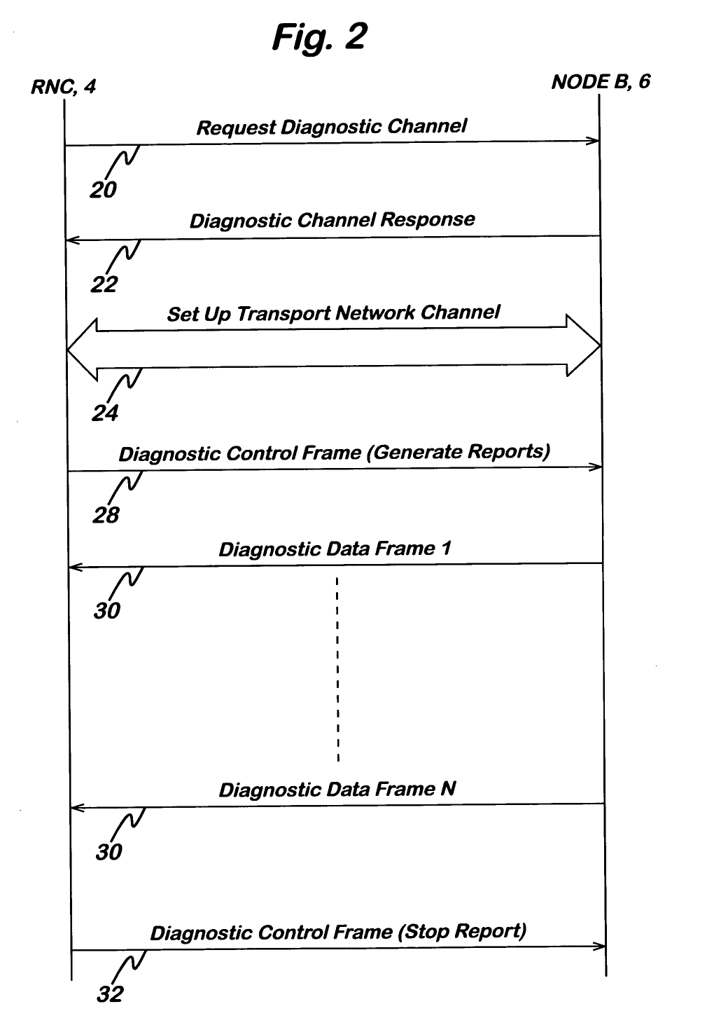

As shown in FIG. 2, a command 20 is sent over the signalling channel (known as the Node-B Application Part (NBAP) channel in UMTS terminology) from the radio network controller (RNC) 4 to the base station 6 requesting a channel for diagnostic information. This command 20 includes, for example, an indication of maximum bandwidth and the priority that the diagnostic channel is given.

The base station 6 responds with a response 22 granting or denying the request.

If the request is granted, the base station 6 passes back identification and addressing information, namely transport layer information, in order to set up a connection. The radio network controller (RNC) then sets up a network transport channel 24 (e.g. asynchronous transfer mode (ATM) in the case of a UMTS network). This network transport channel 24 carries diagnostic traffic and shares the bandwidth available with other transport channels namely user traffic channels (e.g. voice channels). The network transport channel 24 (also known as the diagnostic traffic channel) is set up so that the user traffic channels always take higher priority in terms of being allocated transmission resources than the diagnostic traffic channel. In the base stations 6 and radio network controller (RNC) 4, there are buffers (not shown) for data to be sent on each channel, including buffers for each of the diagnostic traffic and user traffic channels, those buffers having occupancy level indicators such that any non-zero user data level causes user data to be selected for transmission before any remaining transmission resource (i.e., bandwidth) is allocated to lower priority data, such as diagnostic data awaiting transmission.

Frames are used to communicate the diagnostic information between the base station and radio network controller (RNC). Some of the frames 28 are for control signalling and others 30 of the frames are for data. The control frames 28 are used by the radio network controller (RNC) to configure the base station to send appropriate measurement reports in the form of data frames 30, i.e., to instruct the base station 6 to generate reports. Data frames 30 are used to send the measurements back from the base station 6 to radio network controller (RNC) 4. Examples of data that is passed to the radio network controller (RNC) include uplink interference levels for every frame, instantaneous power levels of each radio link, and status of software processes. In some embodiments, the measurements are at least partially standardised, that is defined in a telecommunications standard.

The radio network controller (RNC) 4 stores received diagnostic data from the base station 6.

At the end of the procedure, a command 32 is sent from the radio network controller (RNC) 4 to the base station 6 that instructs the base station 6 to stop generating reports (i.e., frames 30) of diagnostic data.

The request 20 for a diagnostic channel by the radio network controller (RNC) 4 can be triggered (by an engineer) using the local maintenance terminal 14 connected to the radio network controller (RNC) 4. The diagnostic data is sent back to the local maintenance terminal 14 for inspection by the engineer.

In another embodiment (not shown) the local maintenance terminal can be part of the operations and maintenance centre (OMC), for example connected to the operations and maintenance centre (OMC) rather than directly to the radio network controller (RNC).

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. A method of communicating data over an interface from a base station of a network for mobile telecommunications to a base station controller operative to control the base station, comprising storing user data and diagnostic data for transmission, selecting user data for transmission in preference to diagnostic data, and selecting diagnostic data traffic for transmission when no user traffic data is stored for transmission.

2. A method according to claim 1, wherein the network is a Universal Mobile Telecommunications System (UMTS) network, the controller is a radio network controller (RNC), and the interface is an IuB interface.

3. A method according to claim 1, wherein the diagnostic data is provided to a local maintenance terminal connected to the controller for inspection.

4. A method according to claim 1, wherein there are a plurality of data communication channels between the base station and the controller over the interface, one channel being a diagnostic data channel, and another channel being a user data channel, the base station includes a plurality of data buffers such that data of each channel for transmission is stored before transmission in a respective buffer, the buffers each including an occupancy indicator so that user data is selected for transmission in preference to data from the buffer for diagnostic data.

5. A method according to claim 4, wherein the controller includes a plurality of further data buffers, such that control data of each channel for transmission to the base station is stored before transmission in a respective buffer, the further buffers each including an occupancy indicator so that user channel control data is selected for transmission in preference to diagnostic channel control data.

6. A method according to claim 4, wherein the diagnostic data channel is set up in response to a request from the controller to the base station, and control data which is a request for diagnostic data is sent by the controller to the base station, diagnostic data being sent in response.

7. A method according to claim 6, wherein updated diagnostic data is sent periodically until control data which is a command to stop sending diagnostic data is received by the base station.

8. A network for mobile telecommunications comprising a base station connected via an interface with a base station controller operative to control the base station, the base station comprising storing means operative to store user data and diagnostic data for transmission, selecting means operative to select user data for transmission in preference to diagnostic data and to select diagnostic data traffic for transmission when no user traffic data is stored for transmission.

9. A network according to claim 8, in which the network is a Universal Mobile Telecommunications System (UMTS) network, the controller is a radio network controller (RNC), and the interface is an IuB interface.

10. A network according to claim 8, wherein there are a plurality of data communication channels between the base station and the controller over the interface, one channel being a diagnostic data channel, and another channel being a user data channel, the base station includes a plurality of data buffers such that data of each channel for transmission is stored before transmission in a respective buffer, the buffers each including an occupancy indicator so that user data is selected for transmission in preference to data from the buffer for diagnostic data.
